(19) United States
(12) Patent Application Publication
(10) Pub. No.: US 2014/0139686 A1
(43) Pub. Date: May 22, 2014

(54) Digital Camera and Image Capturing Method Thereof

(71) Applicant: BENQ CORPORATION, Taipei City (TW)

(72) Inventor: Chia-Nan Shih, Taipei City (TW)

(73) Assignee: BENQ CORPORATION, Taipei City (TW)

(21) Appl. No.: 14/083,513

(22) Filed: Nov. 19, 2013

(30) Foreign Application Priority Data
Nov. 20, 2012 (TW) 101143285

(51) Int. Cl. H04N 5/232

(52) U.S. Cl. CPC H04N 5/232; H04N 5/23219
USPC 348/169

(57) ABSTRACT

An image capturing method for a digital camera includes the following steps: capturing a plurality of pre-captured images in sequence, wherein each of the pre-captured images includes a plurality of sections; capturing a plurality of captured images based on the number of sections and piecing the plurality of captured images together as an output image, wherein an image capturing optical setting value of each captured image is substantially the same; a target section is selected among the plurality of sections while capturing the plurality of captured images, and an indicating signal is outputted by determining the relative position between an object and the target section based on the plurality of pre-captured images.

### BACKGROUND OF THE INVENTION

1. Field of the Invention

The present invention generally relates to a digital camera; in particular, the present invention relates to a digital camera that can indicate moving position to a captured object.

2. Description of the Prior Art

Digital cameras have advantages of low use cost, instant result-checking, and easy-to-post production. Files stored in digital form can be transmitted and shared conveniently via Internet. Besides, digital cameras may be integrated with mobile phones, notebooks, and consumer electronics, which are widely used in daily life.

In order to take photos with desired effects, the user usually misses the best moment of taking photos due to repeatedly checking whether the position of an object is correct. If the user wants to take a self-photo, he/she should try and compare the position of captured images several times to get a desired result, causing the waste of time.

Besides, for photos with special effects, although the current technique can combine the background and objects in a same photo, the current technique such as multi-exposure still has a deficiency of uneven illumination in captured images that need to be improved by software, resulting in inconvenience of use.

### SUMMARY OF THE INVENTION

One object of the present invention is to provide a digital camera and an image capturing method that can provide an indication of a position of an object.

Another object of the present invention is to provide a digital camera and an image capturing method that can produce a photo having uniform optical conditions.

A digital camera includes an image capturing module that captures a plurality of pre-captured images in sequence, wherein each of the pre-captured images comprises a plurality of sections. A processing module receives and identifies the plurality of pre-captured images, captures a plurality of captured images based on the number of sections, and pieces the plurality of captured images together as an output image. An image capturing optical setting value of each captured image is substantially the same. A target section is selected among the plurality of sections while capturing the plurality of captured images, and an indicating signal is outputted by determining the relative position between an object and the target section based on the plurality of pre-captured images. A position indicating module receives the indicating signal for outputting a user signal

An image capturing method for the digital camera includes the following steps: capturing a plurality of pre-captured images in sequence, wherein each of the pre-captured images includes a plurality of sections; capturing a plurality of captured images based on the number of sections, and piecing the plurality of captured images together as an output image, wherein an image capturing optical setting value of each captured image is substantially the same; a target section is selected among the plurality of sections while capturing the plurality of captured images, and an indicating signal is outputted by determining the relative position between an object and the target section based on the plurality of pre-captured images.

### BRIEF DESCRIPTION OF THE DRAWINGS

FIG. 1 is a schematic view of an embodiment of a digital camera;

FIGS. 2A to 2C are schematic views of selecting different auxiliary lines as pre-captured images;

FIGS. 3A to 3C are schematic views of an embodiment of determining an object and a target section;

FIG. 4 is a flowchart corresponding to embodiments in FIGS. 3A to 3C;

FIG. 5A and FIG. 5B are schematic views of an embodiment of determining the movement of the object;

FIG. 6 is a flowchart corresponding to embodiments in FIG. 5A and FIG. 5B;

FIG. 7 is a schematic view of an embodiment of determining the moving direction of the object by rotating a screen;

FIG. 8A and FIG. 8B are schematic views of another embodiment of determining the movement of the object;

FIG. 9 is a flowchart corresponding to embodiments in FIG. 8A and FIG. 8B;

FIGS. 10A to 10D are schematic views of an embodiment of cutting captured images;

FIG. 11 is a schematic view of an embodiment of piecing sectional images;

FIG. 12 is a schematic view of another embodiment of cutting captured images; and

FIG. 13 is a flowchart of piecing sectional images.

### DETAILED DESCRIPTION OF THE PREFERRED EMBODIMENT

The present invention relates to a digital camera and an image capturing method thereof. In order to indicate an object moving to a predetermined position correctly while taking photos, a digital camera will divide a picture into several sections before taking photos. One of the sections will be selected at every time the photos is to be taken and a signal is outputted to indicate the object where to move, so that the object will move to the section according to the signal and then the photo is taken. After all sections have been selected and photos have been taken, the digital camera will cut photos based on selected sections; finally, cut images will be pieced together as an outputted image.

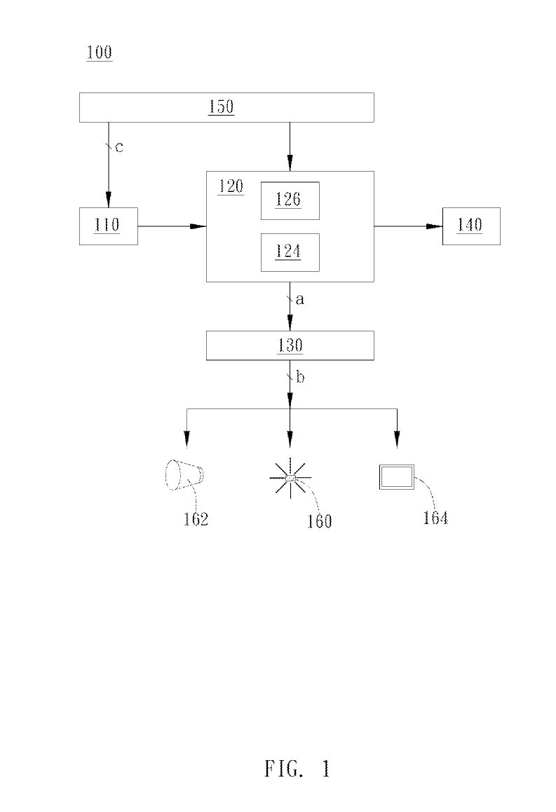

FIG. 1A is a schematic view of an embodiment of a digital camera. The digital camera 100 includes an image capturing module 110, a processing module 120, and a position indicating module 130. The image capturing module 110, such as lenses and optical sensing units, captures pre-captured images under a preview mode or a preparation mode, and then the pre-captured images are received and identified by the processing module 120. The pre-captured images may be served for previewing images and may be utilized to identify an object. Each of the pre-captured images includes a plurality of sections, i.e. a picture is divided into different parts. The number of sections represents different areas in the real space and preferably corresponds to the number of photos required for generating a final outputted image, but it is not limited thereto. The processing module 120 will select one target section from the sections to confirm the object and then determine the relative position between the object and the target section. In a preferred embodiment, the processing module 120 will determine the relative position between the object and the target section based on the pre-captured images during the confirmation process. After the object is confirmed, the processing module 120 outputs an indicating signal (a) to the position indicating module 130. The position indicating module 130 outputs a user signal (b) to a light source 160, a speaker 162, or a screen 164 based on the indicating signal (a) to indicate a moving direction of the object. The relative position mentioned above includes, but not limited thereto, outside the target section, inside the target section, distance to the center of the target section, and approaching a specific boarder of the target section. A shutter command is provided to trigger a shutter when the user determines him/her being in the right position based on the user signal (b). The image capturing module 110 receives a shutter signal (c) generated by an I/O module 150 based on the shutter command. The processing module 120 receives a captured image from the image capturing module 110 and then receives a plurality of captured images in sequence corresponding to the number of sections. Finally, an image processing unit 126 of the processing module 120 cuts each of the captured images corresponding to the sections and pieces the cut images together as the output image and stores the output image in a memory module 140.

Besides, the processing module 120 further includes a characteristic identifying unit 124. When the processing module 120 determines the relative position between the object and the target section based on the pre-captured images, the characteristic identifying unit 124 can provide a determination of the relative distance. As such, the processing module 120 not only can utilize pre-captured images to indicate the moving direction of the object to the target section but also can utilize the characteristic identifying unit 124 to indicate the adjustment of the relative distance. On the other hand, the characteristic identifying unit 124 can also identify the object's figure, facial expressions, etc. as an auxiliary judgment to identify the object.

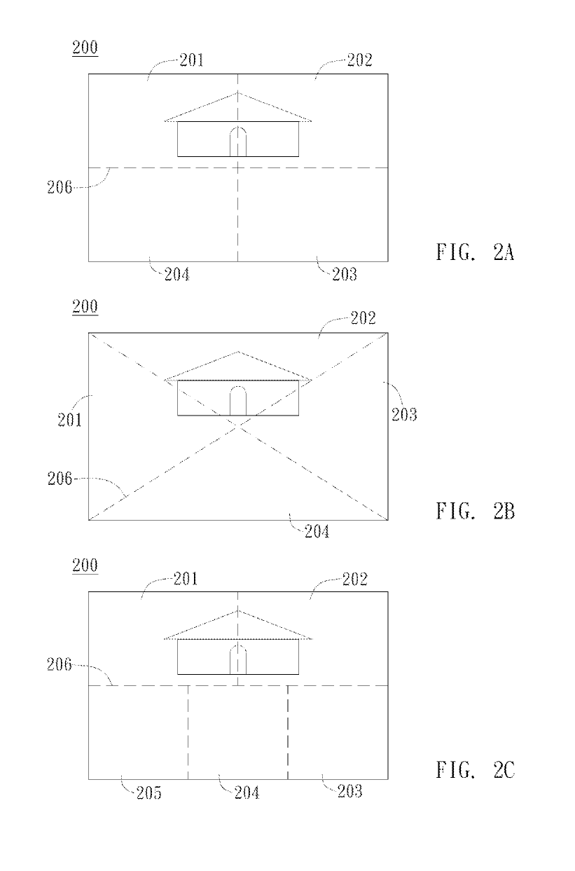

FIG. 2A represents a picture 200 shown on the screen of the digital camera based on the pre-captured image. In the preview mode, after the user finds a view, an auxiliary line 206, such as the cross line shown in FIG. 2A, will divided the picture 200 into a first target section 201, a second target section 202, a third target section 203, and a fourth target section 204. In other words, the auxiliary line 206 can make each of the pre-captured image having different sections. In addition, the form or type of the auxiliary line 206 may be changed according to requirements, such as the X form shown in FIG. 2B or the five-section form as shown in FIG. 2C that divides the picture to have the first target section 201, the second target section 202, the third target section 203, the fourth target section 204, and a fifth section 205. Forms or types of the auxiliary line 206 may be stored in the digital camera in advance for selecting a preset section type. In addition, the user preferably can define a desired section-divining form through the I/O module according to the requirements, for example, by using a stylus or editing the section-dividing form by build-in software of auxiliary lines. In the aforementioned method, after the user selects the auxiliary line, pre-captured images will be outputted to the processing module by the image capturing module, so that the processing module can proceed with the identification process.

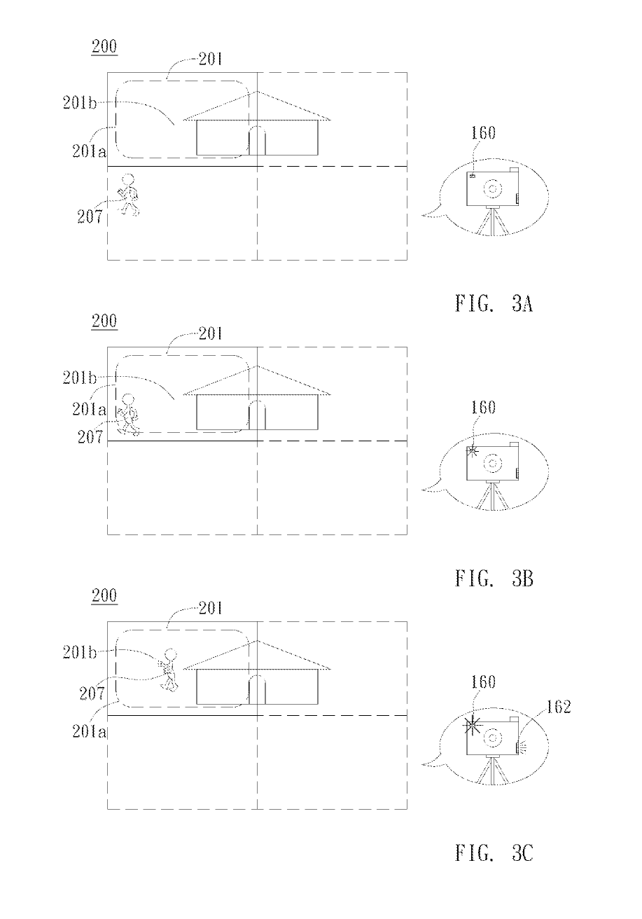

FIG. 3A to FIG. 3C are schematic views of an embodiment of determining an object 207 and a target section. Please also refer to the flowchart shown in FIG. 4. As mentioned above, the image capturing method includes the following steps: S102: activating a preview mode; S104: selecting a type of auxiliary lines; S106: capturing the pre-captured image.

And then the next step is S108: selecting a target image. Taking the auxiliary line 206 shown in FIG. 2 as an example, the processing module preferably chooses the first target section 201 in the upper left of the picture as a reserved region after taking the photo. As shown in FIG. 3A, the first target section 201 has a periphery area 201a and a center area 201b. the periphery area 201a is preferred a boundary region of the target section that is close to the auxiliary line 206, and the center area 201b is a region surrounded by the periphery area 201a.

After the first target section 201 is selected by the processing module, the following steps include: S110: whether the object 207 is in the target section? If not, then the next step is S111: outputting a first indicating signal. As shown in FIG. 3A, a first indicating signal is outputted as the user signal when the object 207 is outside the target section 201. For example, the light source 160 is activated but not flashing.

When the object 207 is aware of the first indicating signal, the object 207 keeps moving until the object 207 is in the target section 201. If the object 207 is in the target section, then goes to S112: whether the object 207 is in the center area? If the object 207 is in the periphery area 201a, then goes to S113: outputting a second indicating signal. If the object 207 is in the center area 202b, then goes to S114: outputting a third indicating signal. As shown in FIG. 3B, when the processing module determines the object 207 is in the periphery area 201a of the first target section 201, the second indicating signal is continually outputted as the user signal, for example, by flashing light at a slower speed. In FIG. 3C, the object 207 keeps moving toward the center area 201b; when the processing module determines the object 207 is in the center area 201b, the third indicating signal is continually outputted, for example, by flashing light at a faster speed and incorporation with a sound effect provided by the speaker 162. In a preferred embodiment, the processing module can identify several continuous pre-captured images to obtain the relative position between the object 207 and the target section 201 in each of the pre-captured images. Then, positions of the object in each of the pre-captured images are compared to identify the moving direction of the object, and different user signals will be outputted according to different moving directions (such as away or approaching the center area).

Then the next step is S116: to determine whether there is any predetermined facial expression or gesture? If yes, the next step is S118: taking the captured image and storing the captured image. As shown in FIG. 3C, when the object 207 poses the gesture and prepares to be taken a photo in the center area 201b of the first target section 201, the image processing unit of the processing module can drive the image capturing module based on a first shutter signal to obtain a captured image of the first target section 201. In contrast, if no predetermined facial expression or gesture is detected, the third indicating signal is continually outputted. In a preferred embodiment, the first shutter signal is outputted directly by the user in a form of infrared rays, Bluetooth, or other remote control methods. In another embodiment, the characteristic identifying unit of the processing module can preset a shutter-triggered gesture or action for identifying whether the gesture or action of the object 207 matches the preset one. If they match, the first shutter signal is transmitted by the I/O module, and then the image capturing module will obtain one captured image. The processing module receives the captured image as an initial image based on the first shutter signal and records optical setting values while taking photo, such as time of exposure, focus, ISO value, and so on. Then the object 207 moves to another section to sequentially complete the capture of images in every section for all sections. It is noted that photo-taking conditions in each section depend on the optical setting value as the photo is taken in the first target section 201, so that the visual effect in each section can be identical. By flashing light or other indicating methods, the object 207 can self-determine whether his/her position is correct so as to save time in taking photos.

For positions where photos are taken, it is not limited to the center area as described in the embodiments shown in FIGS. 3A to 3C. In other embodiments, the object 207 can move to other specific position in the first target section 201. Once the object 207 is aware of the light source 160 emitting signals that indicate the location of the object 207 is in the periphery area 201a of the first target section, such as flashing light at a slower speed mentioned in FIG. 3B, and the user poses a predetermined gesture or triggers the remote control, the processing module will output the first shutter signal. As such, by means of user signals generated from different indicating signals, the user can determine the relative position between the target section and his/her position to put himself in the desired position (such as the center area 201b or the periphery area 201a).

Further, for the characteristic identification, in addition to the preset gesture mentioned above, facial expressions, such as smile, shouting face, etc., may be included as a judgment method. On the other hand, settings of the shutter signal can be changed based on a preset characteristic. For example, the user may set four kinds of facial expressions respectively corresponding to one of the four sections as shown in FIG. 3A, and these facial expressions will trigger a first shutter signal, a second shutter signal, a third shutter, and a fourth shutter signal, respectively. When the object 207 poses the facial expression in each of the sections, the processing module will output the corresponding shutter signal. In other embodiments, the user can set the same facial expression or gesture in each of the sections. In such a situation, only one shutter signal is required.

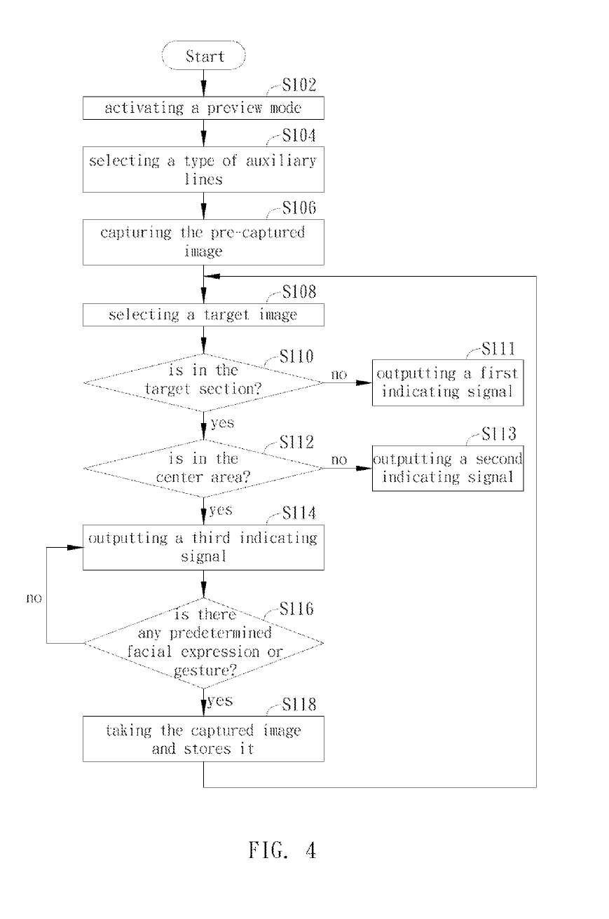

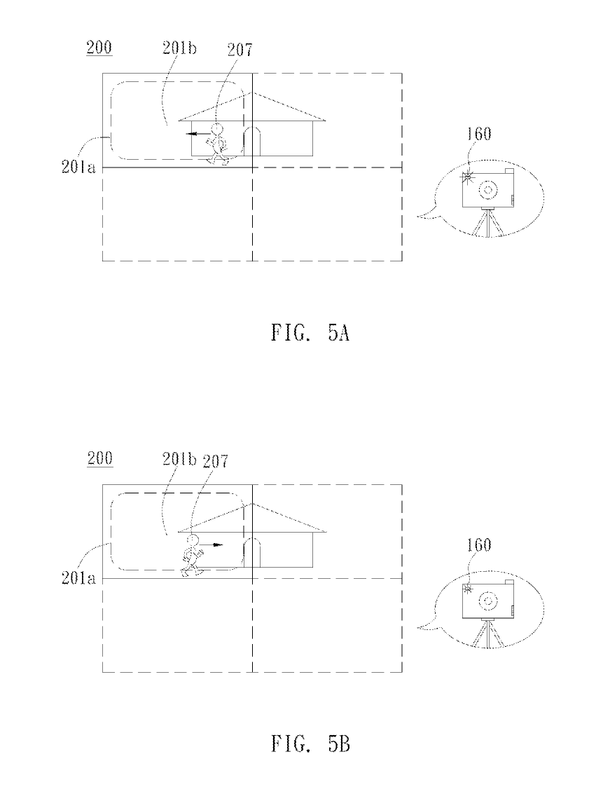

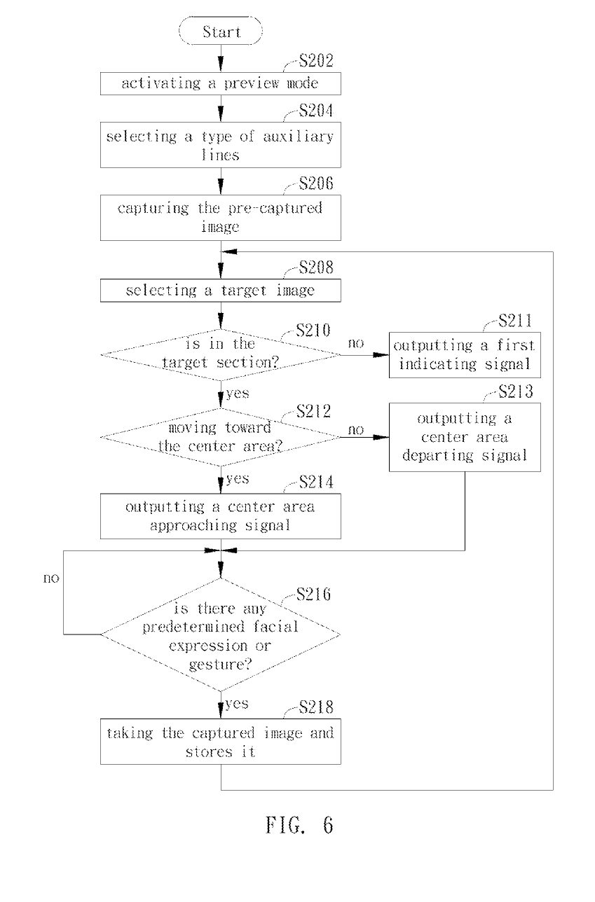

FIGS. 5A and 5B are schematic views of an embodiment of determining the movement of the object 207. Please also refer to the flowchart shown in FIG. 6, wherein steps S202˜S211 correspond to S102˜S111 shown in FIG. 4 and will not be elaborated hereinafter. As shown in FIG. 5A, the target section includes the center area 201b and the periphery area 201a, and the processing module will generate different lighting based on the moving direction of the object 207, i.e. corresponding to the step S212: to determine whether to move toward the center area? If the object 207 moves away from the center area, then goes to S213: outputting a center area departing signal; if the object 207 moves toward the center area, then goes to S214: outputting a center area approaching signal.

For example, when the processing module determines that the object 207 is in the target section, and the object 207 moves toward the center area from an outer part of the target section, the processing module outputs a center area approaching signal as the indicating signal. For example, the light source 160 becomes brighter. In contrast, when the processing module determines that the object 207 is in the target section, and the object 207 moves toward the periphery area from the center area, the processing module outputs a center area departing signal as the indicating signal. For example, the light source 160 becomes darker.

The next step is S216: to determine where there is any predetermined facial expression or gesture? If yes, the next step is S218: taking the captured image and storing the captured image. Then taking photo in the next target section. If no predetermined facial expression or gesture is detected, an indicating signal which indicates the location of the object is continually outputted (the center area approaching signal or the center area departing signal).

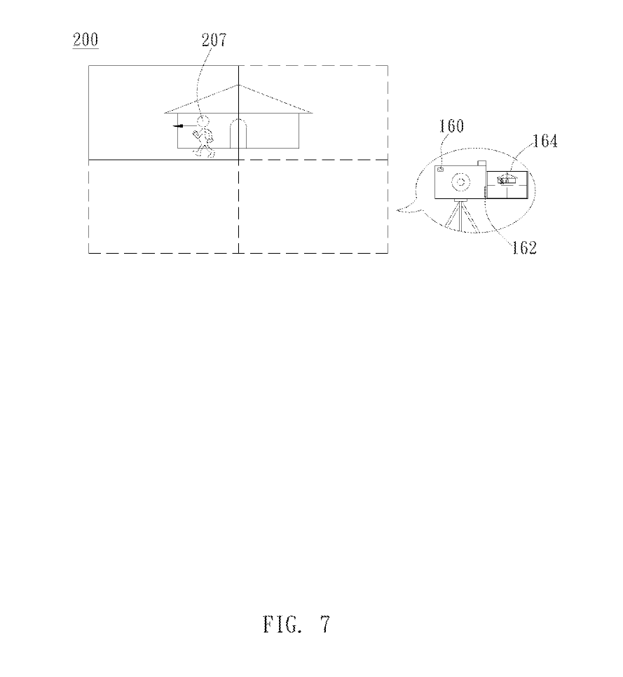

FIG. 7 is a schematic view of an embodiment of determining the moving direction of the object by rotating a screen. As shown in FIG. 7, by rotating the screen 164, the object 207 can determine where to move based on the image displayed on the screen 164. At this time, the image displayed on the screen represents the indicating signal. Further, in addition to rotating the screen 164, the object 207 may utilize methods such as emitting light by the light source 160 or making sound or artificial voice by the speaker 162 to determine the moving direction. Besides, in different embodiments, the rotatable screen can be served as indicating lighting, or displaying on the screen to show which section is taking photo currently. Because the image is upside down after the screen is rotated, the rotated image and relative positions of sections therein will automatically rotate after rotating the screen.

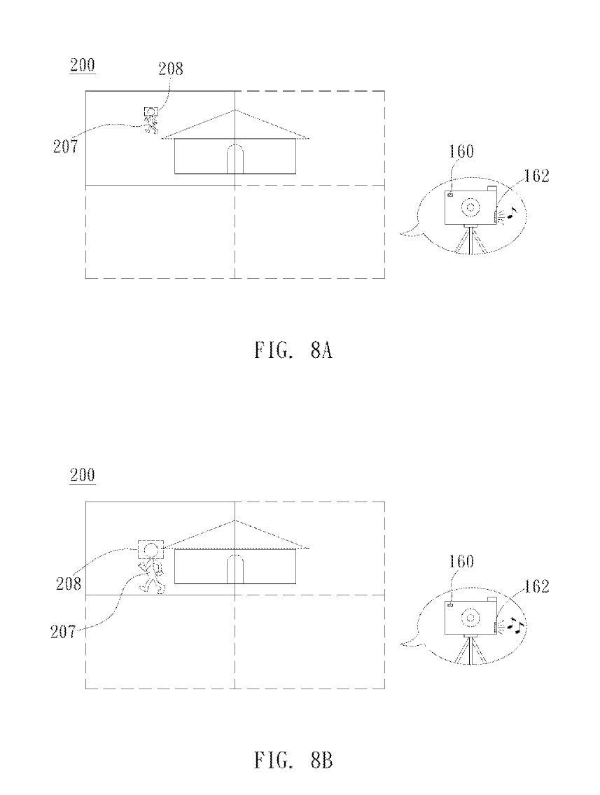

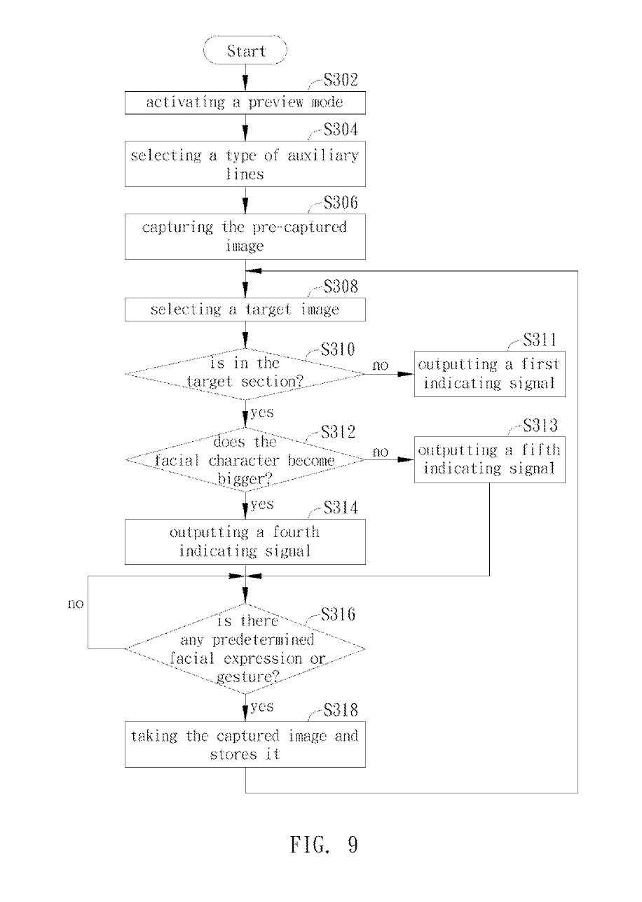

FIGS. 8A and 8B are schematic views of another embodiment of determining the movement of the object 207. Please also refer to the flowchart shown in FIG. 9, wherein steps S302˜S311 correspond to S102˜S111 shown in FIG. 4 and will not be elaborated hereinafter. In this embodiment, if the object is in the target section, then goes to the step S312: to determine whether the facial character becomes bigger? As shown in FIG. 8A and FIG. 8B, a frame 208 at the face of the object 207 is generated by the characteristic identifying unit while taking photos. If the facial character becomes bigger, then goes to S314: outputting a fourth indicating signal. As shown in FIG. 8B, when the area of the frame 208 increases, it represents the object moving toward the digital camera; at this time, the processing module outputs the fourth indicating signal and makes sound by the speaker 162, such as “beep! beep!”. If the facial character becomes smaller, then goes to S313: outputting a fifth indicating signal. As shown in FIG. 8A, when the area of the frame 208 decreases, it represents the object moving away from the digital camera; at this time, the processing module outputs the fifth indicating signal and makes sound by the speaker 162, such as “beep!”. The next step is S316: to determine where there is any predetermined facial expression or gesture? If yes, the next step is S318: taking the captured image and storing the captured image. Then, the steps of taking photo are repeated for the next target section. If no predetermined facial expression or gesture is detected, an indicating signal which indicates the location of the object is continually outputted (the fourth indicating signal or the fifth indicating signal).

In addition, information about the face or the type of build or other data can be stored in advance. If there are many passers-by appearing while taking photos, the characteristic identifying unit can identify the object 207 based on the pre-stored data to prevent misidentification. Besides, when the object enters or leaves the target section via the upper or lower boundary. At this time, the processing module can output the corresponding user signal after identifying.

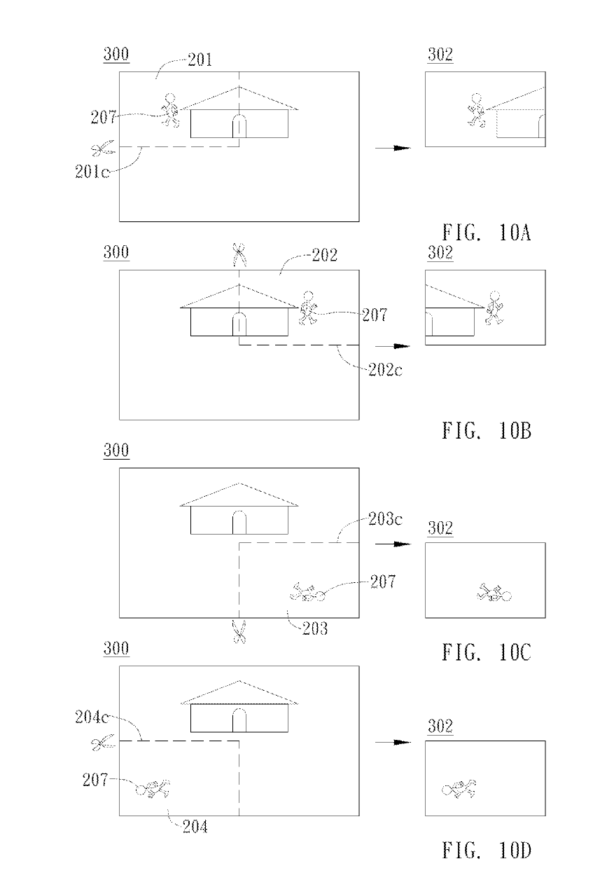

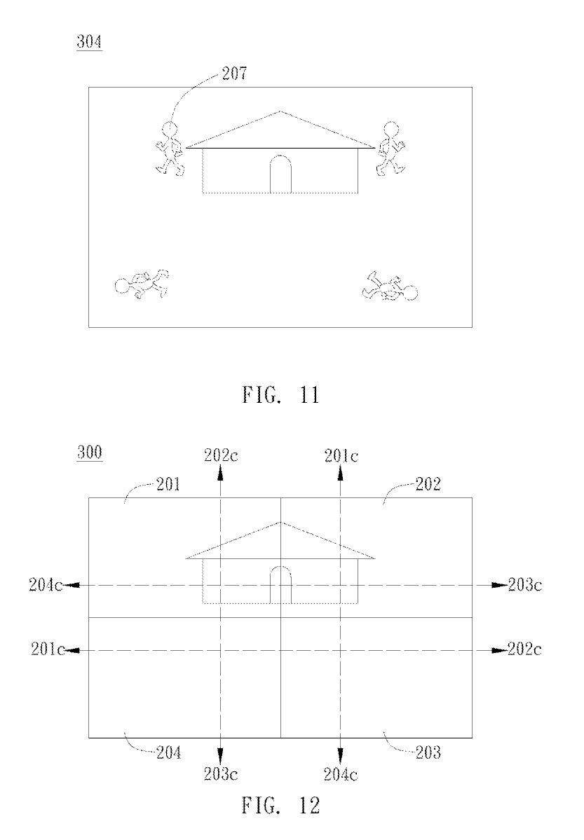

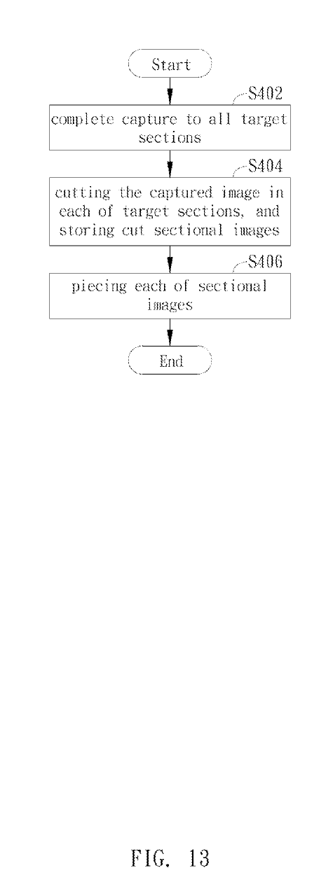

FIG. 10A to FIG. 10D are schematic views of an embodiment of cutting captured images, and the corresponding flowchart is shown in FIG. 13. After images have been captured in each of sections, the image processing unit will cut the initial images. Steps of piecing sectional images include: S402: completing the capture of images for all target sections; S404: cutting the captured image in each of target sections, and storing the cut images. As shown in FIG. 10A, the object 207 is in the first target section 201, so the image processing unit cuts along a cutting line 201c, i.e. aligning the boarder of the first target section 201 defined by the auxiliary line and cutting a first section image 302. Similarly, in FIGS. 10B to 10D, cutting a second section image 302, a third section image 302, and a fourth section image 302. Then the next step is S406: piecing each of the section images, i.e. piecing cut images 302 together as an integral output image according to their original positions. As shown in FIG. 11, the output image 304 shows four objects in one scene. According to the number of sections, a corresponding number of captured images are captured and pieced together as the output image. Because the optical setting value of each of the captured images is substantially the same, the output image having identical visual effect can be obtained.

The aforementioned cutting method is processed after the photos have been taken for all sections, but in other embodiment, the image processing unit can also be set in a manner that each of the captured images is cut as the section image 302 and then stores the sectional image 302 in a memory, so that the memory space will be saved. Besides, the cutting method may be utilized in different ways. Please refer to FIG. 12. FIG. 12 is a schematic view of another embodiment of cutting the captured images. In FIGS. 10A to 10D, the cutting method is cutting the captured image 300 by aligning the cutting line to the boarder defined by the auxiliary line. In other embodiments, the cutting line can be slightly larger than the boarder of the target section. As shown in FIG. 12, the area surrounded by cutting lines 201c, 202c, 203c, and 204c are slightly larger than the area of the first target section 201, the second target section 202, the third target section 203, and the fourth target section 204. When the user takes photos in a handheld manner, cutting a larger area can be selected to edit the captured images. As such, even the user takes photos in a handheld manner that may cause the region of each captured image to be different, the image processing unit still can cut and analysis the captured images based on the larger cutting area to align the section images.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An image capturing method for a digital camera, comprising:
capturing a plurality of pre-captured images in sequence, wherein each of the pre-captured images includes a plurality of sections; and
capturing a plurality of captured images based on the number of sections and piecing the plurality of captured images together as an output image, wherein an image capturing optical setting value of each captured image is the substantially same,
wherein a target section is selected among the plurality of sections while capturing the plurality of captured images, and an indicating signal is outputted by determining the relative position between an object and the target section based on the plurality of pre-captured images.

2. The image capturing method of claim 1, wherein if the object is not in the target section while determining the relative position between an object and the target section, a first indicating signal as the indicating signal is continuously outputted until the object is in the target section.

3. The image capturing method of claim 1, wherein the target section comprises a center area and a periphery area, the image capturing method further comprises:
outputting a second indicating signal as the indicating signal when the object is in the target section and located in the periphery area; and
outputting a third indicating signal different from the second indicating signal as the indicating signal when the object is in the target section and located in the center area.

4. The image capturing method of claim 1, wherein the target section comprises a center area, the image capturing method further comprises:
outputting a center area approaching signal as the indicating signal when the object is in the target section and moves toward the center area; and
outputting a center area departing signal different from the center area approaching signal as the indicating signal when the object is in the target section and moves from the center area toward outside of the target section.

5. The image capturing method of claim 1, wherein the digital camera has a characteristic identifying function, the image capturing method further comprises:
activating the characteristic identifying function and generating a frame according to a characteristic of the object;
outputting a fourth indicating signal as the indicating signal when the area of the frame increases; and
outputting a fifth indicating signal different from the fourth indicating signal as the indicating signal when the area of the frame decreases.

6. The image capturing method of claim 1, further comprising:
receiving a first shutter signal and capturing an initial image from the plurality of captured images when the object is in the target section; and
receiving a second shutter signal which differs from the first shutter signal and capturing a latter image from the plurality of captured images when the object is in another target section.

7. The image capturing method of claim 6, wherein the step of receiving the first shutter signal further comprises:
determining whether the object has an identifying facial expression or gesture; and
outputting the first shutter signal when the object has the identifying facial expression or gesture.

8. The image capturing method of claim 6, further comprising:
cutting the initial image and storing a first section image corresponding to the target section;
cutting the latter image and storing a second section image corresponding to the other target section; and
piecing the first section image and the second section image together as the output image.

9. The image capturing method of claim 1, wherein the indicating signal drives one of an indicating light, an indicating voice, an artificial speech, and a characteristic indicating image displayed on a screen.

10. The image capturing method of claim 1, wherein the digital camera has a screen, the image capturing method further comprises:
displaying the plurality of pre-captured images on the screen under a preview mode; and
displaying an auxiliary line on the screen, wherein the auxiliary line corresponds to the region of the plurality of sections and separates the pre-captured image.

11. A digital camera, comprising:
an image capturing module capturing a plurality of pre-captured images in sequence, wherein each of the pre-captured images comprises a plurality of sections;
a processing module receiving and identifying the plurality of pre-captured images, capturing a plurality of captured images based on the number of sections and piecing the plurality of captured images together as an output image, wherein an image capturing optical setting value of each captured image is substantially the same, a target section is selected among the plurality of sections while capturing the plurality of captured images, and an indicating signal is outputted by determining the relative position between an object and the target section based on the plurality of pre-captured images; and
a position indicating module receiving the indicating signal for outputting a user signal.

12. The digital camera of claim 11, wherein if the object is not in the target section while the processing module is determining the relative position between an object and the target section, a first indicating signal as the indicating signal is continuously outputted until the object is in the target section.

13. The digital camera of claim 11, wherein the target section comprises a center area and a periphery area, the processing module outputs a second indicating signal as the indicating signal when the processing module determines the object being in the target section and located in the periphery area, and the processing module outputs a third indicating signal different from the second indicating signal as the indicating signal when the processing module determines the object being in the target section and located in the center area.

14. The digital camera of claim 11, wherein the target section comprises a center area, the processing module outputs a center area approaching signal as the indicating signal when the processing module determines the object being in the target section and moving toward the center area, and the processing module outputs a center area departing signal different from the center area approaching signal as the indicating signal when the processing module determines the object being in the target section and moving from the center area toward outside of the target section.

15. The digital camera of claim 11, wherein the processing module comprises a characteristic identifying unit, wherein the characteristic identifying unit generates a frame according to a characteristic of the object, the processing module outputs a fourth indicating signal as the indicating signal when the area of the frame increases, and outputs a fifth indicating signal different from the fourth indicating signal as the indicating signal when the area of the frame decreases.

16. The digital camera of claim 11, wherein the processing module comprises a image processing unit, wherein the image processing unit captures an initial image from the plurality of captured images based on a first shutter signal when the object is in the target section, and captures a latter image from the plurality of captured images based on a second shutter signal which differs from the first shutter signal when the object is in another target section.

17. The digital camera of claim 16, wherein the first shutter signal is outputted when the processing module determines the object having an identifying facial expression or gesture.

18. The digital camera of claim 16, wherein the image processing unit cuts the initial image and stores a first section image corresponding to the target section, cuts the latter image and stores a second section image corresponding to the other target section, and pieces the first section image and the second section image together as the output image.

19. The digital camera of claim 11, wherein the user signal is selected from one of an indicating light, an indicating voice, an artificial speech, and a characteristic indicating image displayed on a screen.

20. The digital camera of claim 11, further comprising a screen, the plurality of pre-captured images and an auxiliary line being displayed on the screen under a preview mode, wherein the auxiliary line corresponds to the region of the plurality of sections and separates the pre-captured image.
